(19) United States
(12) Patent Application Publication
(10) Pub. No.: US 2012/0252662 A1
(43) Pub. Date: Oct. 4, 2012

(54) NITROGEN DOPED CARBON NANOTUBES WITH METAL NANOPARTICLES

(75) Inventors: Jens Assmann, Hilden (DE); Aurel Wolf, Wuelfrath (DE); Leslaw Mleczko, Dormagen (DE); Oliver Felix-Karl Schlueter, Leverkusen (DE)

(73) Assignee: BAYER INTELLECTUAL PROPERTY GMBH, Monheim (DE)

(21) Appl. No.: 13/515,470

(22) PCT Filed: Dec. 14, 2010
(86) PCT No.: PCT/EP10/69607

§ 371 Date: Jun. 12, 2012

(30) Foreign Application Priority Data
Dec. 18, 2009 (DE) 102009058833.7

(51) Int. Cl. B01J 31/02; B01J 37/16; B82Y 30/00; B82Y 40/00

(52) U.S. Cl. 502/165; 502/167; 502/166; 977/745; 977/892; 977/773; 977/810

(57) ABSTRACT

The invention relates to nitrogen-doped carbon nanotubes (NCNT), the surface of which is charged with metal nanoparticles, and to a method for the production thereof and use thereof as a catalyst.

The invention relates to nitrogen-doped carbon nanotubes (NCNTs) which are loaded on their surface with metal nanoparticles, and also a process for producing them and their use as catalyst.

Carbon nanotubes have been generally known to those skilled in the art at least since they were described in 1991 by Iijima (S. Iijima, Nature 354, 56-58, 1991). The term carbon nanotubes has since then encompassed cylindrical bodies comprising carbon and having a diameter in the range from 3 to 80 nm and a length which is a multiple of at least 10 of the diameter. A further characteristic of these carbon nanotubes is layers of ordered carbon atoms, with the carbon nanotubes generally having a core having a different morphology. Synonyms for carbon nanotubes are, for example, “carbon fibrils” or “hollow carbon fibers” or “carbon bamboos” or (in the case of wound structures) “nanoscrolls” or “nanorolls”.

Owing to their dimensions and particular properties, these carbon nanotubes are of industrial importance for the production of composites. Further important possibilities are in electronic and energy applications since they generally have a higher specific conductivity than graphitic carbon, e.g. in the form of conductive carbon black. The use of carbon nanotubes is particularly advantageous when they are very uniform in respect of the abovementioned properties (diameter, length, etc.).

It is likewise possible to dope these carbon nanotubes with heteroatoms, e.g. of main group five (for instance nitrogen), during the process for producing the carbon nanotubes.

Generally known methods for producing nitrogen-doped carbon nanotubes are based on the conventional production methods for classical carbon nanotubes, for example electric arc processes, laser ablation processes and catalytic processes.

Electric arc and laser ablation processes are, inter alia, characterized in that carbon black, amorphous carbon and fibers having high diameters are formed as by-products in these production processes, so that the resulting carbon nanotubes usually have to be subjected to complicated after-treatment steps, which makes the products obtained from these processes and thus these processes economically unattractive.

On the other hand, catalytic processes offer advantages for economical production of carbon nanotubes since a product having a high quality may be able to be produced in good yield by means of these processes.

A catalytic process of this type, in particular a fluidized-bed process, is disclosed in DE 10 2006 017 695 A1. The process disclosed there encompasses, in particular, an advantageous mode of operation of the fluidized bed by means of which carbon nanotubes can be produced continuously with introduction of fresh catalyst and discharge of product. It is likewise disclosed that the starting materials used can comprise heteroatoms. Use of starting materials which would result in nitrogen doping of the carbon nanotubes is not disclosed.

A similar process for the targeted, advantageous production of nitrogen-doped carbon nanotubes (NCNTs) is disclosed in WO 2009/080204. In WO 2009/08204, it is disclosed that the nitrogen-doped carbon nanotubes (NCNTs) produced by means of the process can still contain residues of the catalyst material for producing them. These residues of catalyst material can be metal nanoparticles. A process for subsequent loading of the nitrogen-doped carbon nanotubes (NCNTs) is not disclosed. According to the process described in WO 2009/080204, removal of the residues of the catalyst material is further preferred.

However, according to WO 2009/080204, it is always the case that only small proportions of the catalyst material are present in the nitrogen-doped carbon nanotubes (NCNTs) obtained. The group of possible catalyst materials which can be present in small proportions in the nitrogen-doped carbon nanotubes (NCNTs) produced consists of Fe, Ni, Cu, W, V, Cr, Sn, Co, Mn and Mo, and also possibly Mg, Al, Si, Zr, Ti, and also further elements which are known to those skilled in the art and form mixed metal oxide and salts and oxides thereof.

Furthermore, WO 2009/080204 does not disclose the forms in which the nitrogen can be present in the nitrogen-doped carbon nanotubes (NCNTs).

Yan et al. in “Production of a high dispersion of silver nanoparticles on surface-functionalized multi-walled carbon nanotubes using an electrostatic technique”, Materials Letters 63 (2009) 171-173, disclose that carbon nanotubes without heteroatoms can subsequently be loaded with silver on their surface. Accordingly, carbon nanotubes can be subsequently loaded with silver by firstly being functionalized on their surface by means of oxidizing acids such as nitric acid and sulfuric acid. According to the disclosure by Yan et al., functional groups which serve as “anchor sites” for the silver nanoparticles to be deposited are formed on the surface of the carbon nanotubes during the course of the treatment with the oxidizing acids.

The process for loading the oxidized carbon nanotubes according to the disclosure by Yan et al. comprises the steps of dispersion of the oxidized carbon nanotubes in dimethyl sulfoxide, addition of silver nitrate and reduction of the silver by means of sodium citrate on the surface of the oxidized carbon nanotubes.

Since, according to Yan et al., the oxidizing property of the acids is critical, it can be assumed from the disclosure by Yan et al. that the heteroatoms are oxygen and nitrogen-doped carbon nanotubes (NCNTs) are therefore not disclosed as starting point for the carbon nanotubes loaded with silver.

WO 2008/138269 discloses nitrogen-containing carbon nanotubes which bear platinum or ruthenium metal nanoparticles and have a proportion of nitrogen of from 0.01 to 1.34, expressed as the ratio of nitrogen to carbon (CNₓ where x=0.01-1.34). According to WO 2008/138269, the platinum or ruthenium metal nanoparticles have a diameter of from 0.1 to 15 nm and are present in a proportion of from 1 to 100% of the total mass of the nitrogen-containing carbon nanotubes.

The disclosed process for producing the nitrogen-containing carbon nanotubes bearing platinum or ruthenium metal nanoparticles comprises dissolving salts of platinum and of ruthenium in a solution, introducing the nitrogen-containing carbon nanotubes into this solution and reducing the salts of platinum and of ruthenium adsorbed on the surface of the nitrogen-containing carbon nanotubes by means of a chemical reducing agent.

WO 2008/138269 does not disclose that metal nanoparticles other than those of platinum or of ruthenium can be present. Furthermore, WO 2008/138269 also does not disclose the nature of the nitrogen in the nitrogen-containing carbon nanotubes.

The problem of subsequently applying metal nanoparticles to carbon nanotubes and in particular to nitrogen-doped carbon nanotubes (NCNTs) is therefore a problem which has been solved in only a few fields in the prior art.

In particular, there is the problem of providing nitrogen-doped carbon nanotubes (NCNTs) on which any desired metal nanoparticles have been applied in finely dispersed form and in a large amount, and also a process for producing such carbon nanotubes. Such finely dispersed metal nanoparticles on nitrogen-doped carbon nanotubes would be advantageous, in particular, as catalyst materials.

It has now surprisingly been found, as first subject of the present invention, that this object can be achieved by a catalyst comprising nitrogen-doped carbon nanotubes (NCNTs) having a proportion of at least 0.5% by weight of nitrogen of which at least 40 mol % is present as pyridinic nitrogen in the nitrogen-doped carbon nanotubes (NCNTs), wherein from 2 to 60% by weight of metal nanoparticles having an average particle size in the range from 1 to 10 nm are present on the surface of the nitrogen-doped carbon nanotubes (NCNTs).

The nitrogen-doped carbon nanotubes (NCNTs) preferably have a nitrogen content in the range from 0.5% by weight to 18% by weight and particularly preferably in the range from 1% by weight to 16% by weight.

The nitrogen present in the nitrogen-doped carbon nanotubes (NCNTs) of the invention is incorporated in the graphitic layers and is at least partly present as pyridinic nitrogen therein. However, the nitrogen present in the nitrogen-doped carbon nanotubes (NCNTs) of the invention can also be additionally present as nitro nitrogen and/or nitroso nitrogen and/or pyrrolic nitrogen and/or amine nitrogen and/or quaternary nitrogen.

The proportions of quaternary nitrogen and/or nitro and/or nitroso and/or amine and/or pyrrolic nitrogen are of subordinate importance to the present invention since their presence does not significantly hinder the invention as long as the above-described proportions of pyridinic nitrogen are present.

The proportion of pyridinic nitrogen in the catalyst of the invention is preferably at least 50 mol %.

In the context of the present invention, the term “pyridinic nitrogen” describes nitrogen atoms which are present in a heterocyclic compound consisting of five carbon atoms and the nitrogen atom in the nitrogen-doped carbon nanotubes (NCNTs). An example of such a pyridinic nitrogen is shown in figure (I) below.

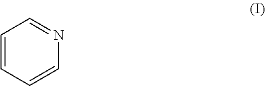

However, the term pyridinic nitrogen refers not only to the aromatic form of the abovementioned heterocyclic compound shown in figure (I) but also the singly or multiply saturated compounds of the same empirical formula.

Furthermore, other compounds are also encompassed by the term “pyridinic nitrogen” when such other compounds comprise a heterocyclic compound consisting of five carbon atoms and the nitrogen atom. An example of such pyridinic nitrogen is shown in figure (II).

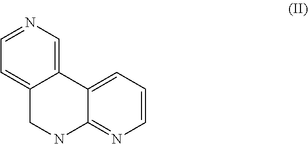

FIG. (II) depicts by way of example three pyridinic nitrogen atoms which are constituents of a multicyclic compound. One of the pyridinic nitrogen atoms is a constituent of a nonaromatic heterocyclic compound.

In contrast thereto, the term “quaternary nitrogen” as used in the context of the present invention refers to nitrogen atoms which are covalently bound to at least three carbon atoms. For example, such quaternary nitrogen can be a constituent of multicyclic compounds as shown in figure (III).

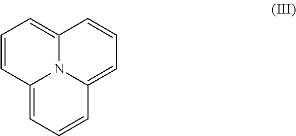

The term pyrrolic nitrogen describes, in the context of the present invention, nitrogen atoms which are present in a heterocyclic compound consisting of four carbon atoms and the nitrogen in the nitrogen-doped carbon nanotubes (NCNTs). An example of a pyrrolic compound in the context of the present invention is shown in figure (IV).

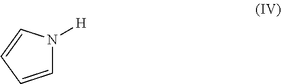

In the context of “pyrrolic nitrogen”, too, this is not restricted to the heterocyclically unsaturated compound shown in figure (IV) but saturated compounds having four carbon atoms and one nitrogen atom in a cyclic arrangement are also encompassed by the term in the context of the present invention.

For the purposes of the present invention, the term nitro or nitroso nitrogen refers to nitrogen atoms in the nitrogen-doped carbon nanotubes (NCNTs) which are, regardless of their further covalent bonds, bound to at least one oxygen atom. A specific form of such a nitro or nitroso nitrogen is shown in figure (V), which is intended to illustrate, in particular, the difference from the abovementioned pyridinic nitrogen.

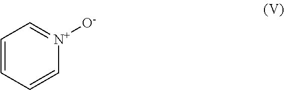

It can be seen from figure (V) that, in contrast to compounds which comprise a “pyridinic nitrogen” in the sense of the present invention, the nitrogen here is also covalently bound to at least one oxygen atom. The heterocyclic compound thus no longer consists only of five carbon atoms and the nitrogen atom but instead consists of five carbon atoms, the nitrogen atom and an oxygen atom.

Apart from the compound shown in figure (V), the term nitro or nitroso nitrogen also encompasses, in the context of the present invention, the compounds which consist of only nitrogen and oxygen. The form of nitro or nitroso nitrogen shown in figure (V) is also referred to as oxidized pyridinic nitrogen.

In the context of the present invention, the term amine nitrogen refers to nitrogen atoms which, in the nitrogen-doped carbon nanotubes (NCNTs), are bound to at least two hydrogen atoms and to not more than one carbon atom but are not bound to oxygen.

The presence of pyridinic nitrogen in the proportions indicated is particularly advantageous because it has surprisingly been found that pyridinic nitrogen in particular simplifies a later loading of the surface of the nitrogen-doped carbon nanotubes (NCNTs) with metal nanoparticles and that this nitrogen species leads, particularly when present in the proportions indicated, to a fine dispersion of the metal nanoparticles on the surface of the nitrogen-doped carbon nanotubes, which is particularly advantageous because of the resulting high specific surface area of the metal nanoparticles.

This particularly good dispersion of the metal nanoparticles on the surface of the nitrogen-doped carbon nanotubes (NCNTs) leads, in particular, to many catalytically active sites being simultaneously available for a reaction on the catalyst surface. This is particularly advantageous for later use of the inventive nitrogen-doped carbon nanotubes (NCNTs) loaded with metal nanoparticles as catalysts in heterogeneous catalysis.

Without wishing to be tied to a theory, it appears that the pyridinic nitrogen groups present anisotropically on the surface of the nitrogen-doped carbon nanotubes (NCNTs) result in the presence of condensation sites for the future metal nanoparticles, with the metal nanoparticles adhering particularly well to the pyridinic nitrogen groups since there is a molecular interaction between the metal nanoparticles and the pyridinic nitrogen groups present on the surface of the nitrogen-doped carbon nanotubes (NCNTs).

That molecular interaction in particular may well lead to the advantageous use of the nitrogen-doped carbon nanotubes (NCNTs) bearing metal nanoparticles compared to the pure metal nanoparticles as improved catalysts, as is likewise provided for by the present invention.

The metal nanoparticles can consist of a metal selected from the group consisting of Fe, Ni, Cu, W, V, Cr, Sn, Co, Mn, Mo, Mg, Al, Si, Zr, Ti, Ru, Pt, Ag, Au, Pd, Rh, Ir, Ta, Nb, Zn and Cd.

The metal nanoparticles preferably consist of a metal selected from the group consisting of Ru, Pt, Ag, Au, Pd, Rh, Ir, Ta, Nb, Zn and Cd.

The metal nanoparticles particularly preferably consist of a metal selected from the group consisting of Ag, Au, Pd, Pt, Rh, Ir, Ta, Nb, Zn and Cd.

The metal nanoparticles very particularly preferably consist of platinum (Pt).

The average particle size of the metal nanoparticles is preferably in the range from 2 to 5 nm.

The proportion of metal nanoparticles on the catalyst comprising nitrogen-doped carbon nanotubes (NCNTs) bearing metal nanoparticles is preferably from 20 to 50% by weight.

The present invention further provides a process for producing nitrogen-doped carbon nanotubes (NCNTs) having metal nanoparticles present on their surface, characterized in that it comprises at least the steps:
a) introduction of nitrogen-doped carbon nanotubes (NCNTs) having a proportion of at least 0.5% by weight of nitrogen of which at least 40 mol % is pyridinic nitrogen into a solution (A) comprising a metal salt,
b) reduction of the metal salt in the solution (A) in the presence of the nitrogen-doped carbon nanotubes (NCNTs), optionally with addition of a chemical reducing agent (R), and
c) separation of the nitrogen-doped carbon nanotubes (NCNTs) now loaded with metal nanoparticles from the solution (A).

The nitrogen-doped carbon nanotubes (NCNTs) used in step a) of the process of the invention are usually ones as can be obtained from the process described in WO 2009/080204.

In a first preferred embodiment of the process, they are nitrogen-doped carbon nanotubes (NCNTs) having a proportion of nitrogen in the range from 0.5% by weight to 18% by weight. They are preferably nitrogen-doped carbon nanotubes (NCNTs) having a proportion of nitrogen in the range from 1% by weight to 16% by weight.

In a second preferred embodiment of the process, they are nitrogen-doped carbon nanotubes (NCNTs) having a proportion of pyridinic nitrogen of at least 50 mol % of nitrogen present in the nitrogen-doped carbon nanotubes (NCNTs).

It has surprisingly been found that prior treatment of the nitrogen-doped carbon nanotubes (NCNTs) before reduction of the metal salt in the presence thereof is not necessary, in contrast to the use of other carbon nanotubes. This applies particularly when the above-described preferred nitrogen-doped carbon nanotubes (NCNTs) are used. Compared to the prior art, this is a significant simplification of the production process.

Without wishing to be tied to a theory, this is obviously made possible by, in particular, the pyridinic surface structures of the nitrogen-doped carbon nanotubes (NCNTs) forming preferential condensation/adsorption sites for metal salts/metal in contrast to the surface structures of “normal” carbon nanotubes.

The solution (A) of a metal salt into which the nitrogen-doped carbon nanotubes obtained as per step a) are introduced is usually a solution of a salt of one of the metals selected from the group consisting of Fe, Ni, Cu, W, V, Cr, Sn, Co, Mn, Mo, Mg, Al, Si, Zr, Ti, Ru, Pt, Ag, Au, Pd, Rh, Ir, Ta, Nb, Zn and Cd.

The metals are preferably selected from the group consisting of Ru, Pt, Ag, Au, Pd, Rh, Ir, Ta, Nb, Zn and Cd. The metals are particularly preferably selected from the group consisting of Ag, Au, Pd, Pt, Rh, Ir, Ta, Nb, Zn and Cd. The metal is very particularly preferably platinum (Pt).

The metal salts are usually salts of the abovementioned metals with a compound selected from the group consisting of nitrate, acetate, chloride, bromide, iodide, sulfate. Preference is given to chloride or nitrate.

The metal salts are usually present in a concentration in the range from 1 to 100 mmol/l, preferably in the range from 5 to 50 mmol/l, particularly preferably in the range from 5 to 15 mmol/l, in the solution (A).

The solvent of the solution (A) is usually one selected from the group consisting of water, ethylene glycol, monoalcohols, dimethyl sulfoxide (DMSO), toluene and cyclohexane.

The solvent is preferably selected from the group consisting of water, DMSO, ethylene glycol and monoalcohols.

The monoalcohols are usually methanol or ethanol, or mixtures thereof.

The use of the particularly advantageous nitrogen-doped carbon nanotubes (NCNTs) having a high proportion of pyridinic nitrogen on their surface enables the further addition of additives, for instance for colloid stabilization, to be dispensed with. Nevertheless, the addition of such additives, for instance for colloid stabilization, can be advantageous in order to improve the catalysts obtained from the process further.

The reduction in step b) of the process of the invention is usually carried out using a chemical reducing agent (R) selected from the group consisting of ethylene glycol, monoalcohols, citrates, borohydrides, formaldehyde, DMSO and hydrazine.

It can thus be seen that the amount of the above-disclosed, possible solvents of the solution (A) is sometimes equal to the amount of the possible reducing agents (R) just disclosed. Accordingly, the further addition of a reducing agent (R) can be dispensed with in many cases.

Preference is therefore given to the chemical reducing agent (R) and the solvent of the solution (A) being at least partly identical.

It has surprisingly been found that in many embodiments of the process of the invention, the process can be simplified by the solvent and the chemical reducing agent (R) being at least partly identical, which is made possible by the nitrogen-doped carbon nanotubes (NCNTs) used in the process of the invention having high proportions of pyridinic nitrogen on their surface, which pyridinic nitrogen serves, as described above, as active site/adsorption point for deposition of the metal on the surface thereof. This high affinity also makes further addition of a reducing agent (R) dispensable in many embodiments.

It can be seen from the above that the expression reduction in the presence of the nitrogen-doped carbon nanotubes (NCNTs) as per step b) of the process encompasses both the reduction of a metal salt on the surface of the nitrogen-doped carbon nanotubes (NCNTs) and the reduction of the metal salt in the solution (A) with adsorption of the metal nanoparticle nuclei formed which takes place in the same solution (A).

A more precise distinction is frequently not possible since, for example, in the case of the reduction in the solution with subsequent adsorption on the surface, these processes take place partly simultaneously.

In particular, however, a distinction is also not necessary since in both cases the advantageous properties of the nitrogen-doped carbon nanotubes (NCNTs) lead, in particular, to finely dispersed metal nanoparticles precipitating on the surface of the nanotubes, so that the catalyst obtained by means of the process of the invention displays, in particular, a very high specific surface area of the metal nanoparticles and subsequent sintering of the metal nanoparticles is likewise prevented or at least greatly reduced by the immobilization of the metal nanoparticles on the surface of the abovementioned condensation sites of the nitrogen-doped carbon nanotubes (NCNTs).

The separation in step c) of the process of the invention is usually carried out using methods as are generally known to those skilled in the art. A nonlimiting example of such a separation is filtration.

The present invention further provides for the use of nitrogen-doped carbon nanotubes (NCNTs) which have a proportion of at least 0.5% by weight of nitrogen of which at least 40 mol % is pyridinic nitrogen and on which from 2 to 60% by weight of the metal nanoparticles having a particle size of from 1 to 10 nm are present as catalysts on the surface of the nitrogen-doped carbon nanotubes (NCNTs).

Preference is given to use as catalysts in electrolysis.

The process of the invention and the inventive catalysts comprising nitrogen-doped carbon nanotubes (NCNTs) bearing metal nanoparticles are illustrated below with the aid of some examples, but the examples are not to be construed as a restriction of the scope of the invention.

In addition, the invention is illustrated with the aid of figures without being restricted thereto.

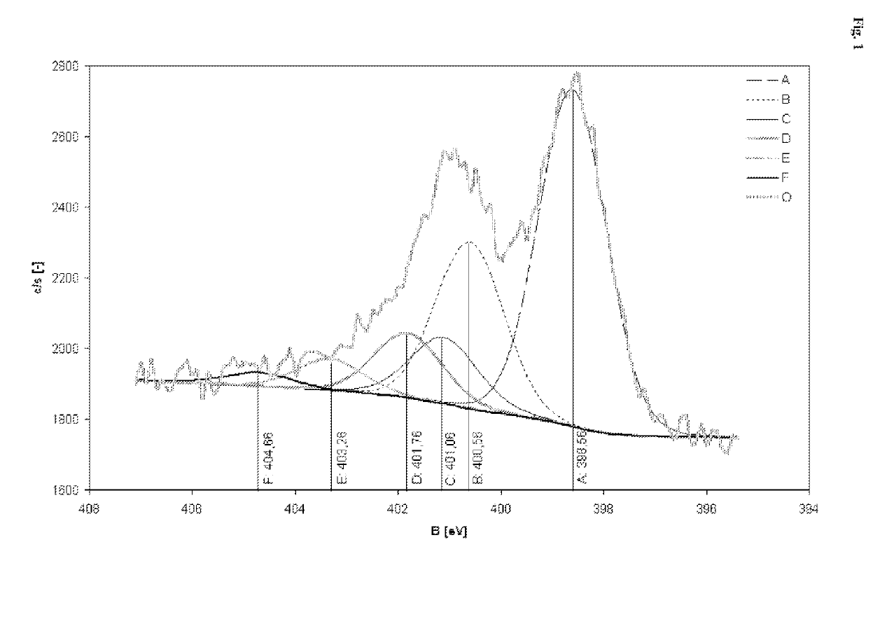

FIG. 1 shows an extract from an X-ray photoelectron spectroscopy study (ESCA) of the nitrogen-doped carbon nanotubes used in example 1. Specifically, the N1is spectrum of the nitrogen-doped carbon nanotubes used in example 1 in the binding energy [B] range from 390 to 410 eV is shown. Under the measured spectrum (O: black, thick, hatched, continuous line), the approximated ideal measurement signals of a pyridinic nitrogen species (A: black, thin, broken line with long sections), a pyrrolic nitrogen species (B: black, thin, broken line with short sections), a first quaternary nitrogen species (C: black, thin continuous line), a second quaternary nitrogen species (D: gray, thick continuous line), a nitroso nitrogen species or oxidized pyridinic nitrogen species (E: gray, thick, hatched line) and a nitro nitrogen species (F: dark gray, thick continuous line) are shown. The respective values of the binding energy (eV) at which the measured value maximum is located for a particular nitrogen species are also shown on the x axis. The sum of the approximated ideal measurement signals in addition gives a smoothed representation of the measured spectrum (O).

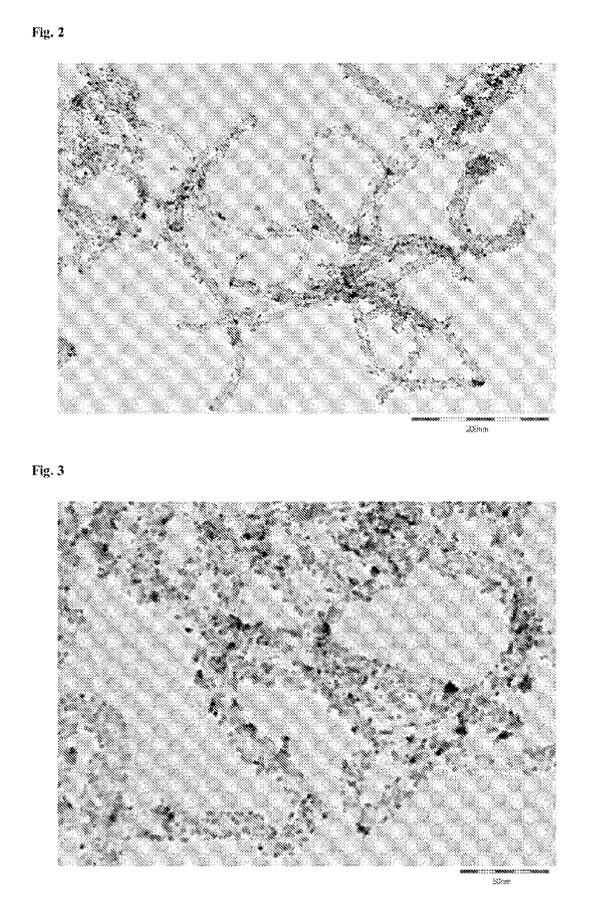

FIG. 2 shows a first transmission electron micrograph (TEM) of the catalyst produced as described in example 1.

FIG. 3 shows a second transmission electron micrograph (TEM) of the catalyst produced as described in example 1.

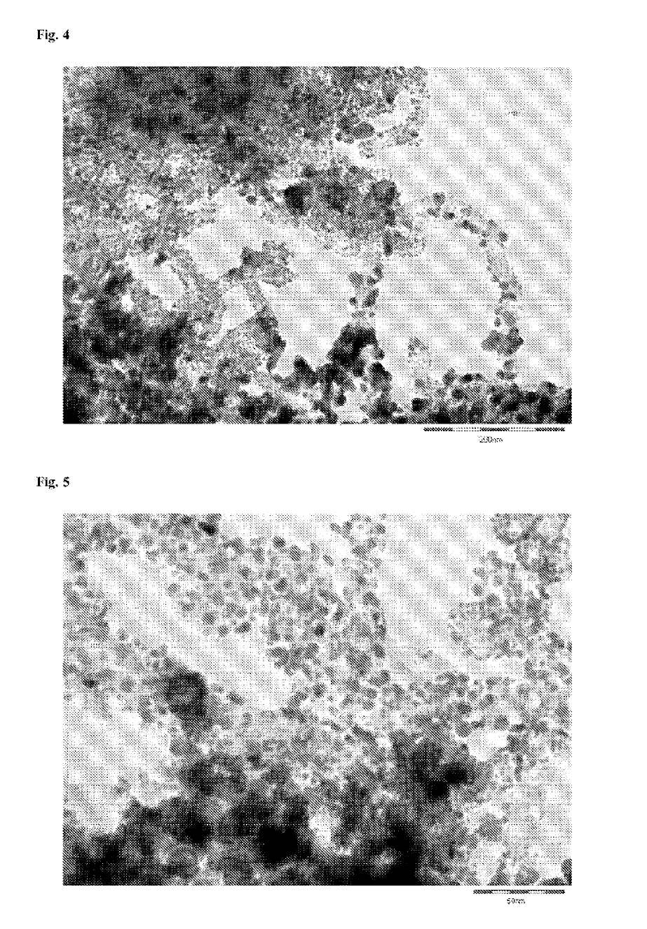

FIG. 4 shows a first transmission electron micrograph (TEM) of the catalyst produced as described in example 2.

FIG. 5 shows a second transmission electron micrograph (TEM) of the catalyst produced as described in example 2.

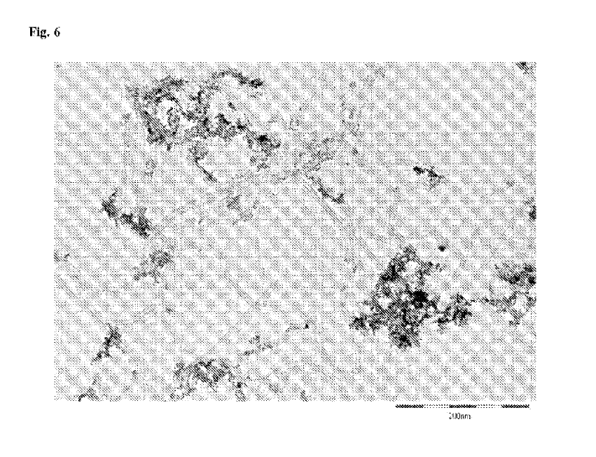

FIG. 6 shows a transmission electron micrograph (TEM) of the catalyst produced as described in example 3.

### EXAMPLES

### Example 1

Production of a catalyst according to the invention

The nitrogen-doped carbon nanotubes were produced as described in example 5 of WO 2009/080204 with the only differences therefrom being that pyridine was used as starting material, the reaction was carried out at a reaction temperature of 700° C. and the reaction time was restricted to 30 minutes.

Residual amounts of the catalyst used (a catalyst was prepared as described in example 1 of WO 2009/080204 and used) were removed by washing the nitrogen-doped carbon nanotubes obtained in 2 molar hydrochloric acid for 3 hours under reflux.

Part of the nitrogen-doped carbon nanotubes obtained were passed to the examination as described in example 4.

The nitrogen-doped carbon nanotubes obtained in this way were subsequently dispersed in 467 ml of ethylene glycol by adding them to this liquid and stirring at 3000 rpm using a SILVERSON stirrer having a stator attachment for 10 minutes.

187 ml of a silver salt solution of 2.5 g of hexachloroplatinic (IV) acid hydrate (from Umicore) in distilled water were subsequently added at a rate of about 1 ml/min to the resulting dispersion of the nitrogen-doped carbon nanotubes. The dispersion was stirred further during this addition. After the addition of the platinum salt solution was complete, the pH of the dispersion was set to 11-12 by means of a 1.5 molar NaOH solution in ethylene glycol.

The dispersion obtained in this way was subsequently transferred to a 3-neck flask and reacted in this at about 140° C. under reflux and a protective gas atmosphere (argon) for 3 hours.

The dispersion was then cooled to room temperature by simply allowing it to stand under ambient conditions (1013 hPa, 23° C.) and subsequently passed through a filter paper (blue band round filter, Schleicher & Schüll) and washed once with distilled water, thus separating the catalyst according to the invention off from the dispersion. The resulting, still moist solid was then dried at 80° C. in a vacuum drying oven (pressure ˜10 mbar) for a further 12 hours.

The catalyst according to the invention was subsequently passed to the, examination as described in example 5.

### Example 2

Production of a first catalyst which is not according to the invention

Nitrogen-doped carbon nanotubes were produced in a manner analogous to example 1 with the sole difference that the reaction was now carried out for 120 minutes.

The nitrogen-doped carbon nanotubes were likewise partly passed to the examination as described in example 4 before dispersion in 467 ml of ethylene glycol.

This was followed once again by a treatment identical to that described in example 1. The catalyst obtained was subsequently likewise passed to the examination as described in example 5.

### Example 3

Production of a further catalyst which is not according to the invention

An experiment identical to that described in example 1 was carried out with the sole difference that commercial carbon nanotubes (BayTubes®, from BayTubes) were now used instead of the nitrogen-doped carbon nanotubes used there.

It follows that, after washing of the carbon nanotubes in 2 molar hydrochloric acid, the production of the catalyst was carried out in the same way.

An examination as described in example 4 was not carried out due to the lack of nitrogen constituents in the commercial carbon nanotubes.

The catalyst obtained was subsequently likewise passed to the examination as described in example 5.

### Example 4

X-ray photoelectron spectroscopy study (ESCA) of the catalysts as described in example 1 and example 2

The proportion by mass of nitrogen in the nitrogen-doped carbon nanotubes and also the molar proportion of various nitrogen species within the proportion by mass of nitrogen found in the nitrogen-doped carbon nanotubes were determined for the nitrogen-doped carbon nanotubes as obtained in the course of example 1 and of example 2 by means of X-ray photoelectron spectroscopic analysis (ESCA; instrument: ThermoFisher, ESCALab 220iXL; method: according to the manufacturer's instructions). The values determined are summarized in table 1.

The determination of the molar proportions of the various nitrogen species or the bonding state of the nitrogen species was carried out by area approximation under the binding energy value characterizing the respective nitrogen species in the N1s spectrum.

| | Measured values as per example 4 | | | | | | | |
|---|---|---|---|---|---|---|---|---|
| | | | | | | | Pyridine | |
| | N content | Pyridine | Amine | Pyrrole | Quater- | Quater- | (oxidized) | |
| | [% by | N | N | N | nary N | nary N | N⁺—O | NOₓ |
| Sample | weight) | [mol %] | [mol %] | [mol %] | [mol %] | [mol %] | [mol %] | [mol %] |
| Ex. 1 | 7 | 48.72 | 0 | 24.21 | 10.07 | 9.71 | 4.92 | 2.36 |
| Ex. 2 | 10 | 39.66 | 0 | 6.5 | 40.54 | 4.05 | 6.67 | 2.58 |

For this purpose, a superposition of the individual measured values characterizing the nitrogen species was assumed, with the resulting proportions being fitted mathematically to the measured spectrum. For the purposes of illustration, this is shown in FIG. 1 for the measured spectrum of the nitrogen-doped carbon nanotubes as per example 1 used according to the invention.

It can be seen from comparison of the nitrogen-doped carbon nanotubes as per example 1 used according to the invention with the noninventive nitrogen-doped carbon nanotubes as per example 2 that although the proportion of nitrogen in the nitrogen-doped carbon nanotubes as per example 2 is higher than in the case of the nitrogen-doped carbon nanotubes as per example 1, the molar proportion of the pyridinic nitrogen species in the nitrogen-doped carbon nanotubes as per example 1 is greater than that in the nitrogen-doped carbon nanotubes as per example 2. The converse in turn applies to the proportions of the quaternary nitrogen.

### Example 5

Transmission electron microscopic (TEM) examination of the catalysts as per example 1, example 2 and example 3

The catalysts obtained as described in examples 1 to 3 were subsequently optically examined for their loading with platinum under a transmission electron microscope (TEM; Philips TECNAI 20, with 200 kV acceleration voltage).

The catalysts according to the invention as per example 1 are shown in FIGS. 2 and 3. It can be seen that the nitrogen-doped carbon nanotubes are loaded with platinum particles having a size of from about 2 to 5 nm finely dispersed on the surface of the nanotubes. The loading of the nitrogen-doped carbon nanotubes with platinum is about 50% by weight of platinum, based on the total mass of the catalyst according to the invention.

In contrast to FIGS. 2 and 3 showing the catalyst according to the invention, FIGS. 4 and 5 relating to the first catalyst which is not according to the invention show that a fine dispersion of platinum particles on the surface of the nitrogen-doped carbon nanotubes has not occurred here.

The platinum particles are predominantly larger than 10 nm and some of them are also present as agglomerates whose size exceeds even the diameter of the nitrogen-doped carbon nanotubes. Accordingly, only the different proportion of pyridinic nitrogen in the nitrogen-doped carbon nanotubes appears to be critical to the desired fine dispersion of the metal on the surface of the nitrogen-doped carbon nanotubes.

This assumption is further supported by the results of the measurement of the catalysts as per example 3. These are shown in FIG. 6.

These results make it clear that the process of the invention for producing the catalysts of the invention which has been demonstrated successfully in example 1 can be carried out without subsequent functionalization of the carbon nanotubes and without the use of additives for stabilizing metal nanoparticles, while the use of carbon nanotubes without a nitrogen content and in particular without a nitrogen content in the form of pyridinic species does not lead to the desired high dispersion of metal nanoparticles on the carbon nanotubes.

The noninventive commercial carbon nanotubes used remain largely not covered and the platinum is present predominantly in the form of agglomerates.

1. A catalyst comprising nitrogen-doped carbon nanotubes (NCNTs) having a proportion of at least 0.5% by weight of nitrogen, of which at least 40 mol % is present as pyridinic nitrogen in the nitrogen-doped carbon nanotubes (NCNTs), wherein from 2 to 60% by weight of metal nanoparticles having an average particle size in the range from 1 to 10 nm are present on a surface of the nitrogen-doped carbon nanotubes (NCNTs).

2. The catalyst as claimed in claim 1, wherein the proportion of said pyridinic nitrogen is at least 50 mol %.

3. The catalyst as claimed in claim 1, wherein said metal nanoparticles comprise a metal selected from the group consisting of Fe, Ni, Cu, W, V, Cr, Sn, Co, Mn, Mo, Mg, Al, Si, Zr, Ti, Ru, Pt, Ag, Au, Pd, Rh, Ir, Ta, Nb, Zn and Cd.

4. The catalyst as claimed in claim 3, wherein said the metal is platinum (Pt).

5. The catalyst as claimed in claim 1, wherein said metal nanoparticles have an average particle size in a range from 2 to 5 nm.

6. A process for producing nitrogen-doped carbon nanotubes (NCNTs) having metal nanoparticles present on a surface thereof, wherein said process comprises at least:
a) introducing nitrogen-doped carbon nanotubes (NCNTs) having a proportion of at least 0.5% by weight of nitrogen of which at least 40 mol % is pyridinic nitrogen into a solution (A) comprising a metal salt,
b) reducing the metal salt in the solution (A) in the presence of the nitrogen-doped carbon nanotubes (NCNTs), optionally with addition of a chemical reducing agent (R), and
c) separating the nitrogen-doped carbon nanotubes (NCNTs) loaded with metal nanoparticles from the solution (A).

7. The process as claimed in claim 6, wherein said nitrogen-doped carbon nanotubes (NCNTs) have a nitrogen content in a range from 0.5% by weight to 18% by weight.

8. The process as claimed in claim 6, wherein said nitrogen-doped carbon nanotubes (NCNTs) have a proportion of pyridinic nitrogen of at least 50 mol %.

9. The process as claimed in claim 6, wherein said chemical reducing agent (R) and a solvent of the solution (A) are at least partly identical.

10. Nitrogen-doped carbon nanotubes (NCNTs) having a proportion of at least 0.5% by weight of nitrogen of which at least 40 mol % is pyridinic nitrogen and on which from 2 to 60% by weight of metal nanoparticles having a particle size of from 1 to 10 nm are present as a catalyst on a surface of the nitrogen-doped carbon nanotubes (NCNTs).
